(19) United States
(12) Patent Application Publication
(10) Pub. No.: US 2009/0248675 A1
(43) Pub. Date: Oct. 1, 2009

(54) METHOD AND SYSTEM FOR SUPPORTING DOCUMENT EVALUATION

(75) Inventors: Kaoru Kawabata, Hitachi (JP); Takeshi Yokota, Hitachi (JP); Kenji Araki, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/389,653

(22) Filed: Feb. 20, 2009

(30) Foreign Application Priority Data
Mar. 31, 2008 (JP) 2008-089172

(51) Int. Cl. G06F 17/30

(52) U.S. Cl. 707/5; 707/E17.014

(57) ABSTRACT

A document evaluation support system narrows the search for related terms in a document, evaluates a search result, provides information of the evaluation, and further searches the search result for a related paragraph in the document so as to support evaluation and determination of the document. The system includes a document division section, a specified term search section, and a search result evaluation section. The sections further include a document attribute database, a document division determination rule database, a document division determination unit, a document division input unit, a divided document (paragraph) with heading database, a keyword database, a numeric database, a search method input unit, a search condition database, a specified result search unit, a search result database, a search result display unit, a weight database, a search result evaluation unit, an evaluation result database, and an evaluation result display unit.

### CLAIM OF PRIORITY

The present application claims priority from Japanese patent application serial no. 2008-089172, filed on Mar. 31, 2008, the content of which is hereby incorporated by reference into this application.

### FIELD OF THE INVENTION

The present invention relates to a document evaluation support system and method capable of getting useful information from a document and supporting term search in the document for confirming matters described in the document.

### BACKGROUND OF THE INVENTION

When evaluating or confirming contents of a document, it is necessary to specify a term to be searched for and find where the term is located in the document. As the methods of retrieving terms, JP-A No. 2003-208447 discloses the method of dynamically determining a requested search term and a related term and displaying retrieved terms in the order of occurrence rates. JP-A No. 1994-215041 discloses the method of retrieving terms in accordance with a numeric condition defined as a document attribute. JP-A No. 1992-293161 discloses the method of retrieving terms by specifying the number of characters between search terms or a search range.

Conventionally, a search for a certain term or terms in a document has been carried out by setting specified conditions such as a term or terms to be searched for, a related term, the number of characters between the terms to be searched for, and an attribute numeric of the document.

Incidentally, depending on the evaluation contents of the document to be evaluated, it is needed to further refine search conditions, improve the accuracy of search refinement, and evaluate search results for increasing the utilization of the search results. That is, there is a need for giving support to not only retrieving a single term but also retrieving a combination of closely related search terms within a specified range, providing evaluation of a search result, and providing and determining information related to the search result.

The present invention is to provide a document evaluation support system capable of narrowing a search for related terms in a document, providing information with evaluation of a search result, and further supporting for evaluation and determination of the document by carrying out a search of a related section such as paragraph or the like or sections in the document from the search result for term.

### SUMMARY OF THE INVENTION

The present invention provides a document evaluation support system for searching a document for a specified term or terms and providing a search result; and the invention is characterized by comprising a device for defining a search condition for the specified term or terms by using a predetermined evaluation method.

In addition to the above-mentioned present invention, the following various preferred examples are provided optionally.

For examples, the system may be configured so that the document may be provided with attribute information and a full text of the document can be divided into one or more sections such as paragraphs or the like automatically or manually.

In the system, the specified term or terms may signify at least one of one or more terms, numerics, numerics with units, sized numerics, and sized numerics with units; and the system is configured to classify each specified term into one or more groups including weighted information according to importance.

In the system, the evaluation method (evaluation process) may provide a constraint condition used when searching the document for the specified term or terms and determine whether or not to search for the specified term or terms in accordance with document attribute information.

In the system, the evaluation method may provide a constraint condition used for searching the document for the specified term or terms and specify a search range in the document to search for the specified term or terms.

In the system, the evaluation method may provide a constraint condition used for searching the document for the specified terms and search for the specified terms restricting a distance between specified terms.

In the system, it may be configured to provide the search result with a display color corresponding to weighted information about each specified term.

In the system, it may be configured to provide the search result by dividing a full text of the document into one or more sections such as paragraphs or the like, calculating an evaluation score by using the number of specified terms and weighted information about each section, and displaying the search result in descending or ascending order of values of the evaluation score.

In the system, it may be configured to provide the search result displaying an alarm phrase and a necessary fixed phrase in accordance with the evaluation method, specified term, and an evaluation score value.

In the system, it may be configured to divide a full text of the document into one or more sections such as paragraphs or the like and search for the specified term or terms included in a selected section across the full text of the document when one of the paragraphs is selected to be searched.

Furthermore, the invention provides a document evaluation support method of searching a document for a specified term or terms and providing a search result, and the method comprising a process of defining a search condition for the specified term or terms by using a predetermined evaluation method.

In the method, the document can be provided with attribute information and a full text of the document can be divided into one or more paragraphs automatically or manually.

In the method, the specified term or terms may signify at least one of one or more terms, numerics, numerics with units, sized numerics, and sized numerics with units, and each specified term may be classified into one or more groups including weighted information according to importance.

In the method, the evaluation method may provide a constraint condition used for searching the document for the specified term or terms and determine whether or not to search for the specified term or terms in accordance with document attribute information.

In the method, it may provide a constraint condition used for searching the document for the specified term or terms and specify a search range in the document to search for the specified term and terms.

In the method, it may provide a constraint condition used for searching the document for the specified terms and search the specified terms restricting a distance between specified terms.

In the method, it may provide the search result using a display color corresponding to weighted information about each specified term.

In the method, when providing the search result, the method may comprise further processes of dividing a full text of the document into one or more sections such as paragraphs or the like, calculating an evaluation score by using the number of specified terms and weighted information about each section, and displaying the search result in descending or ascending order of values of the evaluation score.

In the method, when providing the search result, the search result may be displayed including an alarm phrase and a necessary fixed phrase in accordance with the evaluation method, specified term, and an evaluation score value.

In the method, when searching the document for the specified term or terms, the method may comprise further processes of dividing a full text of the input document into one or more sections such as paragraphs or the like, and searching a selected section for the specified term or terms in the full text of the document when one of divided sections is selected as the section to be searched.

Additionally, the following system is provided. A document evaluation support system is comprised of:

a document database for storing a document to be searched;

a division determination rule database for storing a determination rule for dividing the document into one or more sections;

a division determination unit for automatically dividing a full text of the document into one or more sections such as paragraphs or the like in accordance with the division determination rule;

a division specification input unit for allowing a user to divide a full text of the document into one or more sections;

a paragraph with heading database for storing the paragraphs into which the document is divided automatically or according to user specification with the addition to headings;

a keyword database for storing a term to be searched for;

a numeric database for storing numeric data to be searched for;

a search condition database for storing a constraint condition for a search;

a search process input unit for inputting an evaluation method;

a specified term search unit for searching the document for the specified term;

a search result display unit for displaying a search result;

an evaluation rule database for storing an evaluation rule to evaluate the search result;

a search result evaluation unit for evaluating the search result according to the evaluation rule; and

an evaluation result display unit for displaying an evaluation result.

According to the document evaluation support system and method of the invention, it is possible to specify a certain section such as a paragraph to be searched from among sections such as paragraphs into which a document is divided, search and narrow the certain section for a keyword as a specified term or numerical value and related term or numerical matters, and/or to search other section or sections related to the specified section for the keyword or the like. Thereby, the present invention makes it possible to support a search/evaluation and a confirmatory check for documents.

### BRIEF DESCRIPTION OF THE DRAWINGS

FIG. 1 shows a basic configuration;

FIG. 2 shows a process for dividing a document;

FIG. 3 shows a process for searching an object (target) section in a divided document for a specified term;

FIG. 4 shows a process for evaluating a paragraph from a search result of the paragraph;

FIG. 5 shows a process for searching a certain specified paragraph of the divided document for a term related to the specified term and evaluating the searched term;

FIG. 6 shows a document attribute database format and its examples;

FIG. 7 shows a heading database format and an example;

FIG. 8 shows a keyword database format and an example;

FIG. 9 shows a numeric database format and an example;

FIG. 10 shows a search condition database format and an example;

FIG. 11 shows a search result database format and an example;

FIG. 12 shows an evaluation result and weight database format and examples;

FIG. 13 shows example display screens of an input of a search condition for a specified term, an output of a search result, and an output of an evaluation result; and

FIG. 14 shows example display screens of an input a search condition for a specified paragraph, an output of a search result, and an output of an evaluation result;

### DETAILED DESCRIPTION OF THE PREFERRED EMBODIMENTS

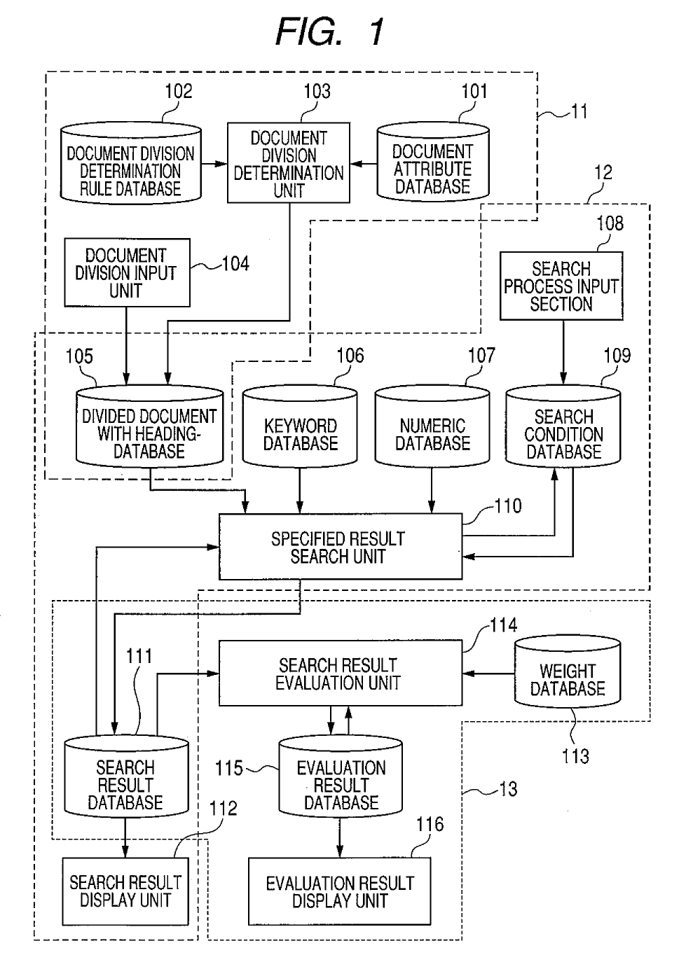

With reference to FIGS. 1 through 12, the following describes an embodiment of the document evaluation support system according of the invention.

FIG. 1 shows a basic configuration of the document evaluation support system according to the invention. The system includes a document division processing section 11, a specified term search section 12, and a search result evaluation section 13. The sections further include a document attribute database 101, a document division determination rule database 102, a document division determination unit 103, a document division input unit 104, a divided document with heading (title)-database 105, a keyword database 106, a numeric database 107, a search process input unit 108, a search condition database 109, a specified result search unit 110, a search result database 111, a search result display unit 112, a weight database 113, a search result evaluation unit 114, an evaluation result database 115, and an evaluation result display unit 116.

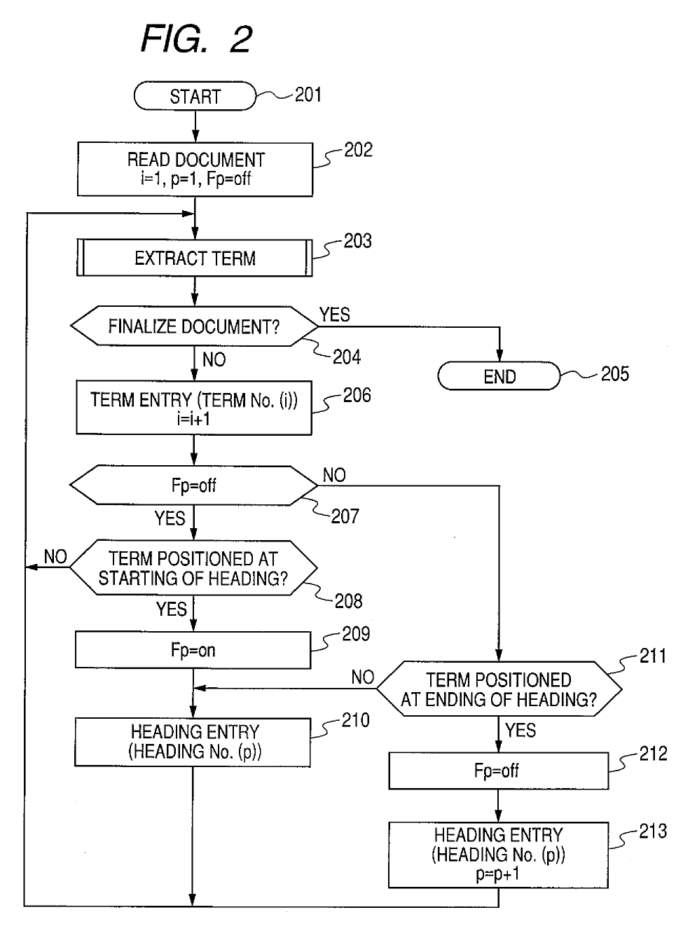

FIG. 2 is a flow chart showing an example process of the document division section 11 in the document evaluation support system shown in FIG. 1.

In the process of FIG. 2, first, after the start at Step 201, a document as an object to be searched is read at Step 202. After that, each term subsequent to each delimiter in the document is extracted by using the delimiter (Step 203). The extracted term is cataloged with the addition of each number at Step 206, and the cataloged term is determined whether or not the term is used as each “heading (title)” positioned at the beginning of a corresponding “section” (such as paragraph) resulting from dividing the document into one or more paragraphs (sections) at Steps 208 and 211. In further details at Steps 208 and 211, the term positioned at a starting of the heading is determined at Step 208, and the term positioned at an ending of the heading is determined at Step 211. Such a determination is carried out by using a document division rule coded in a regular expression or the like. When the cataloged term is determined that it belongs to the heading, its heading number is cataloged at Steps 210 and 213 as paragraph title. In further details at Steps 210 and 213, the term positioned at the starting of the heading is cataloged at Step 210, and the term positioned at the ending of the heading is cataloged at Step 211, respectively. The process is repeated to the end of the document at Step 204 and then terminates at Step 205, and thereby the document (for example, a full text) is divided into one or more paragraphs having each heading.

The division of the document by using determination of the term as the heading may be carried out by specifying a desired term and cataloging the term in addition to the use of the above-mentioned document division rule. In any cases, when the heading of each catalog term is cataloged with the addition of number, the document is divided into one or more paragraphs, and it is possible to carry out to search and evaluate the document on each paragraph.

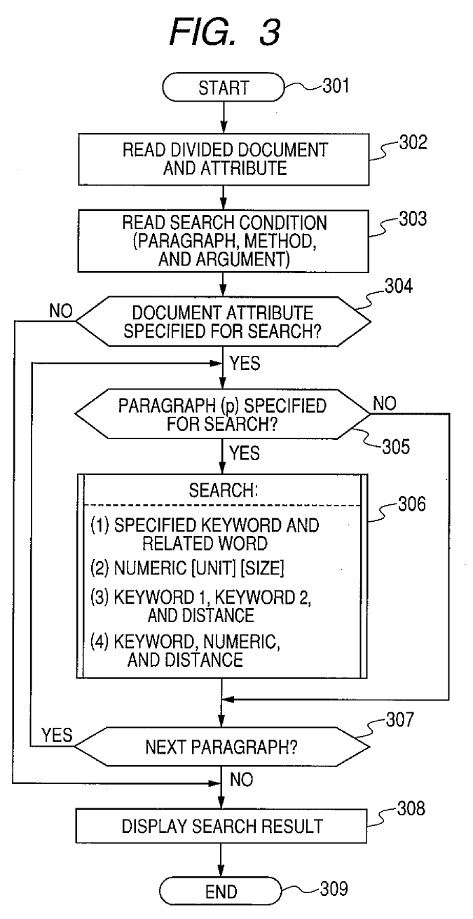

FIG. 3 is a flow chart showing an example process of the specified term search section 12 in the document evaluation support system shown in FIG. 1.

In the process of FIG. 3, after the start at Step 301, the each paragraph resulting from the divided document and its attributes is read at Step 302, and description of a search condition data base, namely the search condition data applied from a search process input unit is read at Step 303. Provided the document attribute has been specified as the search condition, the document attribute is determined whether or not to be an object to be searched for at Step 304. Provided the document attribute is the object to be searched for, the search of the document attribute is carried out. When a certain paragraph of the divided document is specified as the search condition, the paragraph is determined whether or not to be an object to be searched at Step 305. When the paragraph is not the object for the search, the next paragraph is determine whether or not to be an object to be searched.

Provided the paragraph is the object for the search, the process starts searching the paragraph (section) for the specified term at Step 306. In the process, the following four types (1) to (4) of search are available.

(1) The keyword database has stored categorized keywords. When one or more keywords are selected from the keyword database, the selected keyword, its synonymous or similar term or related term are searched for in the paragraph. The number of the searched terms as the keyword, synonymous or similar term, and related term in each paragraph are stored into the evaluation result database from one type to another.

(2) The numeric database has stored numeric data which are combinations of one or more numerics and numeric units. When one or more combinations as the numeric data are selected from the numeric database, the corresponding combination is searched for in the paragraph. Provided there is a size condition for the numeric data, the size is evaluated.

(3) The keyword database has stored categorized keywords. A distance between one selected keyword including its synonymous or similar term and related term and another selected keyword including its synonymous or similar term and related term is determined whether or not the distance is within the specified distance. The distance means a difference of the number of words used between two keywords along with the searched corresponding synonymous or similar term and related term.

(4) As mentioned above, the keyword database stores categorized keywords. The numeric database has stored combinations of numeric data and numeric units. A distance of one selected keyword including its synonymous or similar term and one selected combination of numeric data and numeric unit is determined whether the distance is within the specific distance. Here, the distance means the number of words used for the selected keyword with its synonymous and similar term and the selected combination of numeric data and numeric unit. Provided there is a size condition for the numeric data, the size is evaluated.

The process of the above-mentioned search and determination is carried out for the full text of the document from one paragraph (section) to another (Step 307). As a result of the search and determination, the searched (retrieved) specified term or terms is/are displayed using different character colors or the like in accordance with a type of the search and a type of the searched terms such as keyword, synonymous or similar term, and related term (Step 308). The process then terminates (Step 309).

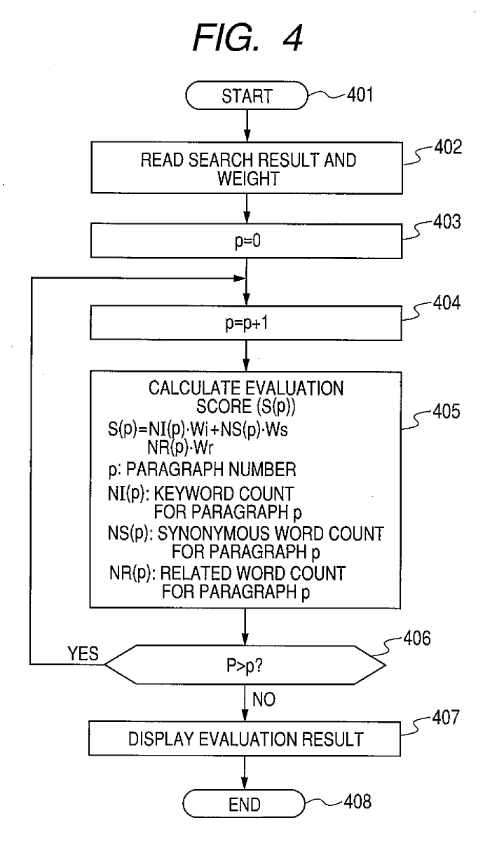

FIG. 4 is a flow chart showing an example process of the search result evaluation section 13 in the document evaluation support system shown in FIG. 1.

The process becomes possible about the followings. When selecting the keyword and searching for the keyword, its synonymous or similar term, and related term, the evaluation for a result of the search process is carried out by using the search result. The evaluation for the result of the search process makes it possible to identify that each of the searched paragraphs (sections) of the divided document is closely associated with the keyword, a paragraph required for confirming the keyword, a paragraph less closely associated with the keyword, and a text that is closely associated with the keyword but is not described the keyword.

In the process of FIG. 4, after the start at Step 401, the search result data and weight data for the evaluation is read at Step 402, an evaluation score S (p) for each paragraph (p) is calculated by using equation (1) at Step 405.

S(p)=NI(p)·Wi+NS(p)·Ws+NR(p)·Wr (1)

### Wherein:

NI(p): The number of specified keywords searched in each paragraph p

NS(p): The number of specified synonymous or similar terms searched in paragraph p

NR(p): The number of specified related terms searched in paragraph p

Wi: Weight of evaluation for the Keyword word

Ws: Weight of evaluation for the number of synonymous or similar terms

Wr: Weight of evaluation for the related term

The above calculation is performed on all the paragraphs (namely full section of the divided documents) (Step 406), the results of the calculation is displayed in ascending or descending order (Step 407), and then the process is terminated (Step 408).

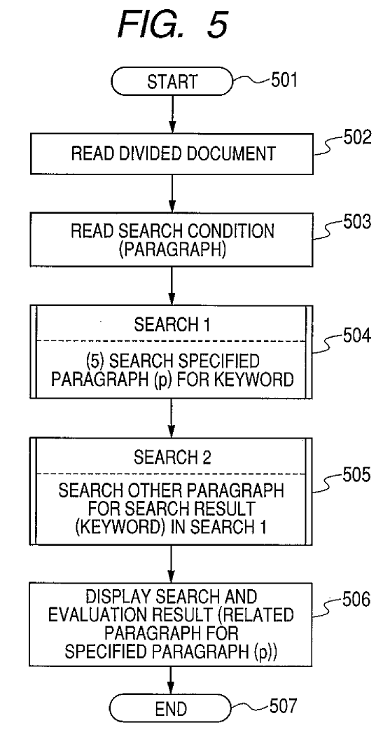

FIG. 5 is a flow chart showing an example process of searching a specified paragraph for the keyword, and then additionally searching another or other paragraphs related to the keyword of the specified paragraph, by using the specified term search section 12 and the search result evaluation section 13 in the document evaluation support system shown in FIG. 1.

In the process of FIG. 5, after the start at Step 501, the full paragraphs (full sections) into which the document is divided is loaded at Step 502; and a specified paragraph on the search condition which supplied to the database 109 from the search process input unit 108 is read is at Step 503. First, the process is performed to search the specified paragraph for the specified keyword at Step 504. Namely, in the specified paragraph as the object to be searched, the search is carried out by using the specified term as the keyword. Next, the process also is performed to search another or other paragraphs for the keyword, its synonymous or similar term, and related term having been searched in the specified paragraph (Step 505). Namely, such a search for the specified term is carried out across all the paragraphs of the divided document for the keyword, its synonymous or similar term, and related term having been searched in the specified paragraph. Finally, the search results is displayed in ascending or descending order (Step 506), and then the process is terminated (Step 507).

The above-mentioned process performs to search the specified paragraph (namely specified section) for the keyword selected from the keyword database and then to also search all the paragraphs of the document for the keyword, synonymous or similar term and related term. Another process may perform to search the specified paragraph for the keyword, its synonymous or similar term stored in the keyword database and then to also search all the paragraphs for the related term.

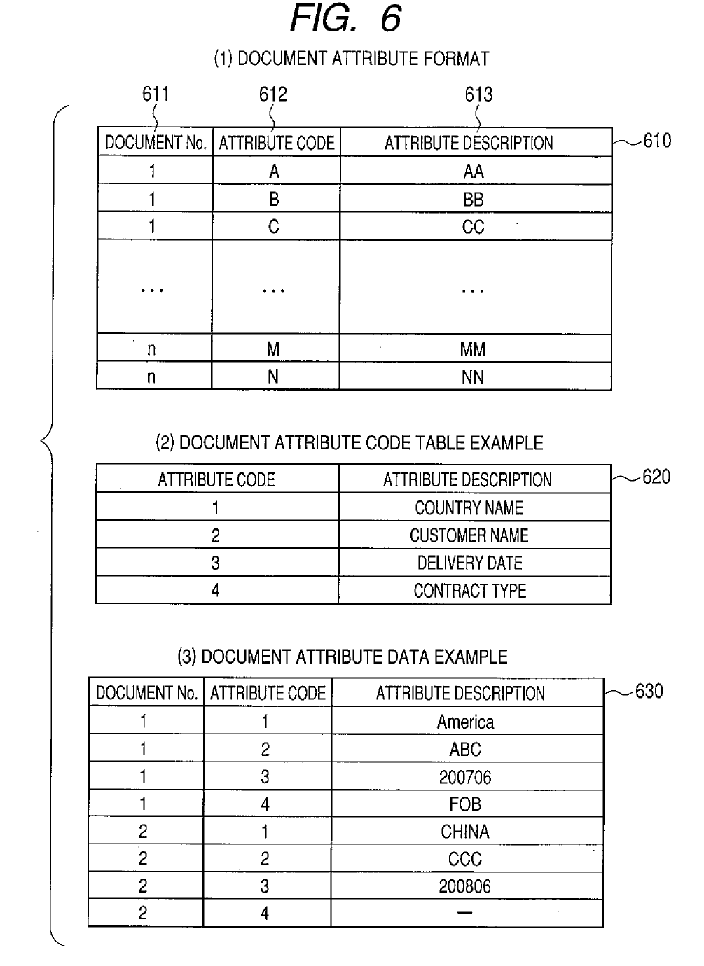

FIG. 6 shows an example attribute database in the document attribute database 101 shown in FIG. 1. A document attribute format 610 includes a document number item 611, an attribute code item 612, and an attribute description item 613. A document attribute code table example 620 shows definition of country name, customer name, delivery date, and contract type which correspond to each attribute code for a document. In a document attribute data example 630, “document number 1” contains “country name” defined as “America” “customer name” as “ABC” “delivery date” as “June in 2007,” and “contract type” as “FOB.”

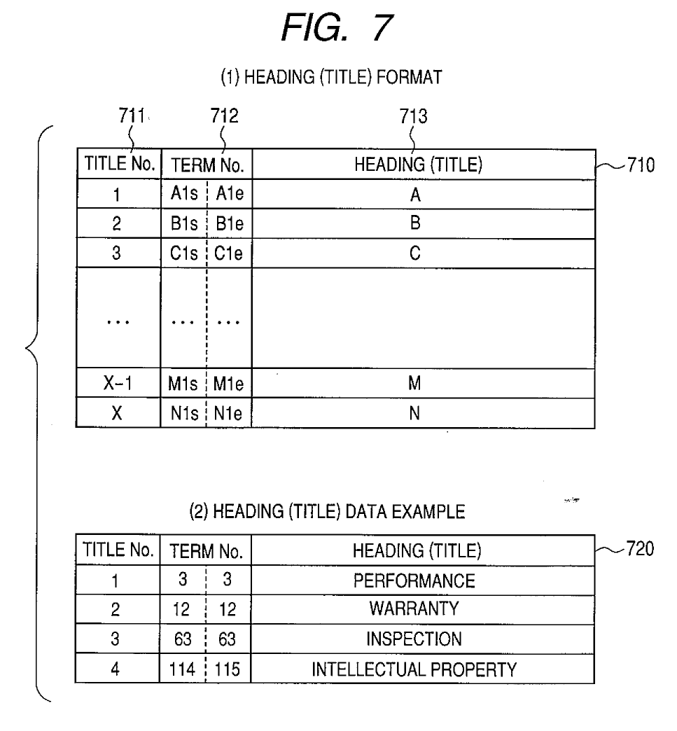

FIG. 7 shows an example heading database in the divided document with heading (title)-database 105 shown in FIG. 1. An heading (title) format 710 includes a title number item 711 as a heading number, a starting term number and ending term number item 712 of the heading, and an heading (title) description item 713. In a heading (title) data example 720, the “heading (title)” for “PERFORMANCE” corresponds to “heading number (title number) 1” and “term number 3” that are determined by the document division determination unit 103 or supplied from the document division input unit 104. Similarly, the “heading (title)” shows “WARRANTY,” “INSPECTION,” and “INTELLECTUAL PROPERTY.”

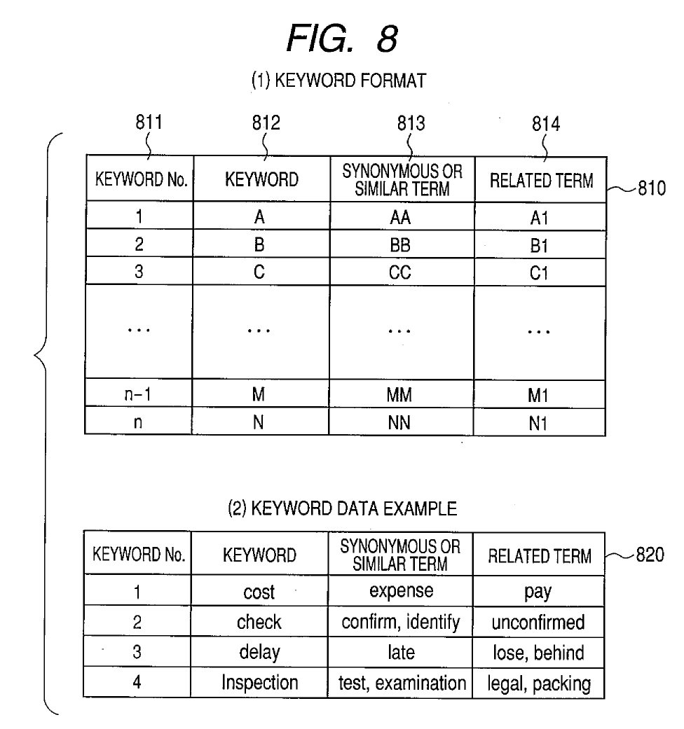

FIG. 8 shows an example of the keyword database 106 in FIG. 1. A keyword format 810 includes a keyword number item 811, a keyword item 812, a synonymous or similar term 813, and a related term item 814. A keyword data example 820 stores “cost” as “keyword” that is associated with “expense” as “synonymous or similar term” and “pay” as “related term.” The keyword database is previously prepared so as to be able to select keywords to be searched for. Further, it is possible to add, delete, and change keywords.

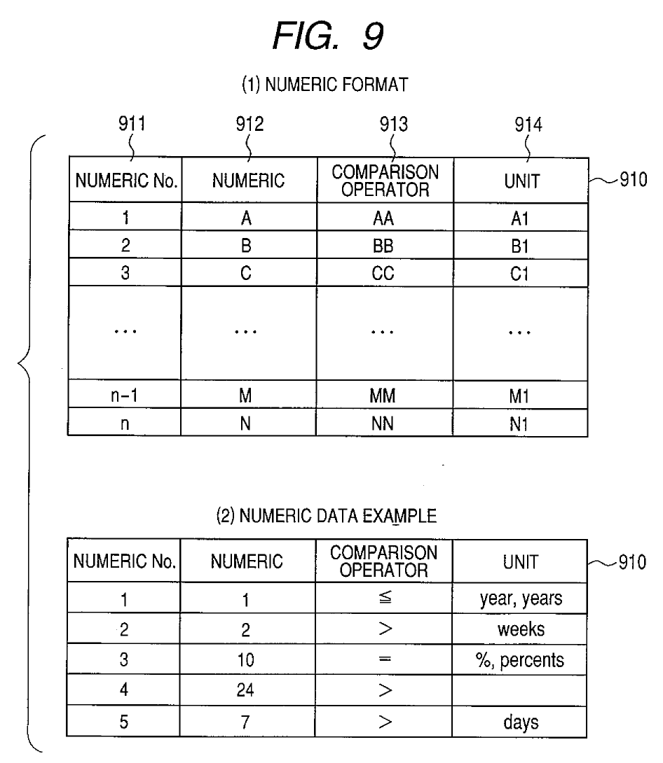

FIG. 9 shows an example of the numeric database 107 in FIG. 1. A numeric format 910 includes a numeric number item 911, a numeric item 912, a comparison operator item 913, and a numeric unit item 914. A numeric data example 920 is indicated that, for example, when “numeric number” is in “1”, since a value of “numeric” is defined as “1”, “comparison operator” as “<” and “unit” as “year or years”, it shows that the numeric value of the numeric number 1 is one year or less. When “numeric number” is in “2”, since a value of “numeric” is defined as “2”, “comparison operator” as “>” and “unit” as “weeks”, it shows that the numeric value 2 is two weeks or more. The numeric database is previously prepared so as to be able to select keywords to be searched for. Further, it is possible to add, delete, and change keywords.

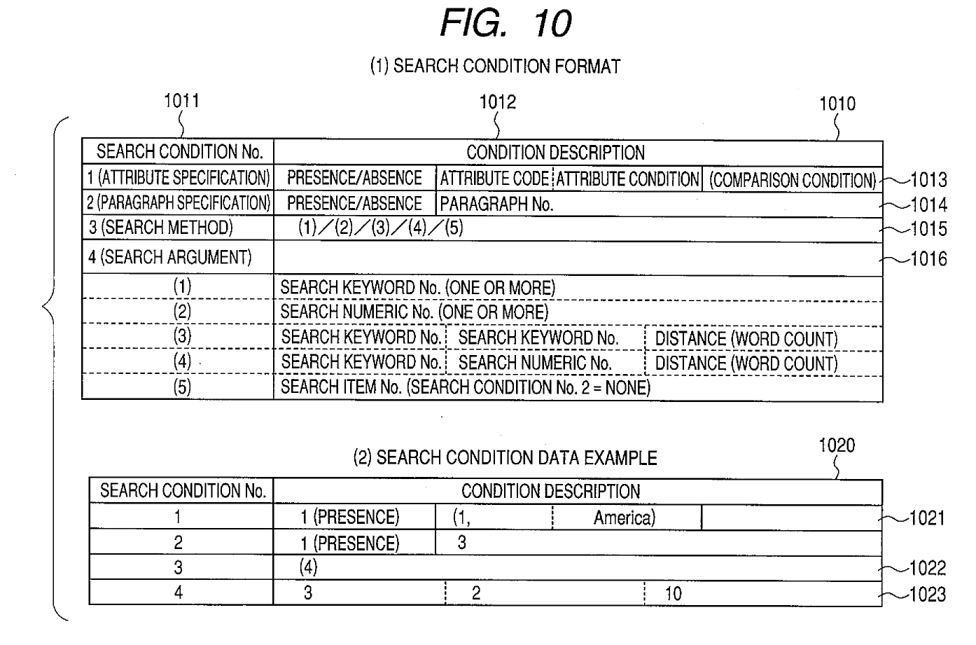

FIG. 10 shows an example of the search condition database 109 into which search condition data is supplied by the search process input unit 108 in FIG. 1. A search condition format 1010 includes a search condition number item 1011 and a condition description item 1012. Four types of search conditions are available as follows. (1) An attribute specification 1013 defines an attribute code and an attribute condition for determining whether or not an attribute of the entire document is to an object to be searched for. Further, when the attribute condition contains numeric data, the attribute specification item 1013 defines a comparison condition for determining the numeric data size. (2) A paragraph specification item 1014 defines a paragraph number as a condition for determining whether or not to search one or more paragraphs resulting from dividing the document. (3) A search method item 1015 specifies any of the four types of search processes mentioned above and the search for related paragraphs based on the paragraph specification according to the flow chart in FIG. 5. (4) A search argument item 1016 defines search arguments needed for the search method specified in the search condition (3). For example, a search condition data example 1020 shows that the search is performed when a document attribute is specified and is set to “1 (country name)” defined as “America”. Additionally, when a certain paragraph of the document is specified, the paragraph to be searched is defined as “3”. The heading database in FIG. 7 stores information as to headings (titles) for paragraphs of the document. The search method is specified as “(4) search under the condition of a distance between the keyword and numeric data”. The condition includes the keyword corresponding to keyword number “3”, numeric number “2”, and distance “10”. The system searches the keyword data example 820 in FIG. 8 and the numeric data example 910 in FIG. 9 for the keyword (keyword) defined as “delay”, and ten words or less including the synonymous or similar term, the related term, and the numeric defined as “2 (weeks)”.

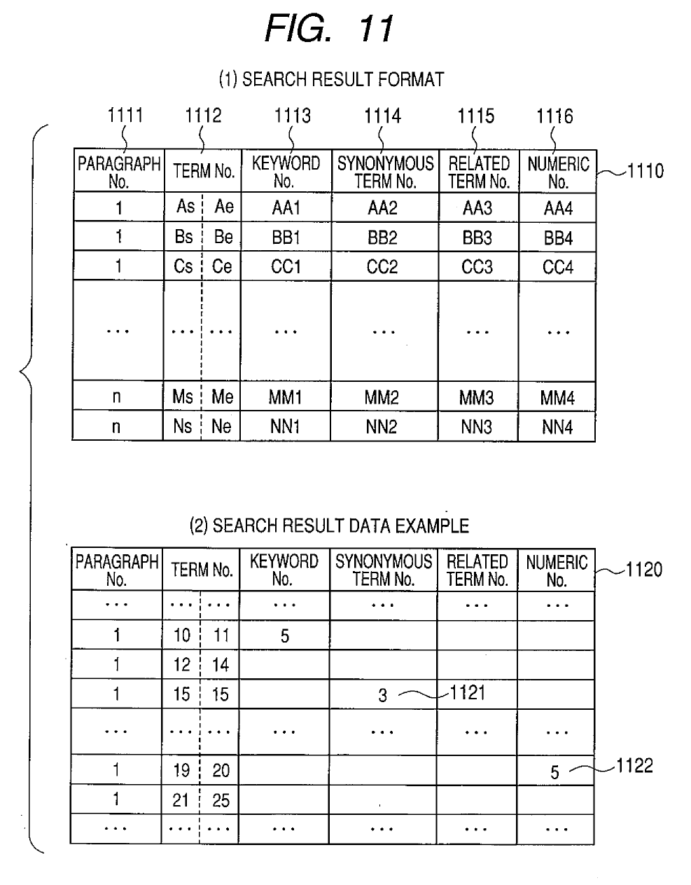

FIG. 11 shows an example of the search result database 111 that provides specified terms and numerics searched by the specified result search unit 110 in FIG. 1. A search result format 1110 is configured to catalog a search result for all terms of the selected paragraph as to whether or not they are applied to the keyword as the searched term, its synonymous or similar term, related term, or searched numeric. Therefore, the search result format 1110 includes a paragraph number item 1111, a starting term number and an ending term number item 1112 for each term, an keyword number item 1113, a synonymous or similar term number item 1114, a related term number item 1115, and a numeric number item 1116. The format can be used to catalog a keyword number of the keyword database or a numeric number of the numeric database for each term number in the search result. Thereby, the system is capable of searching the paragraph for the specified term while using the distance between two terms or the distance between a term and a numeric, displaying of term search results in different colors, and searching evaluation on a paragraph basis. In a search result data example 1120, reference numeral 1121 shows that term number 15 of the paragraph corresponds to keyword number 3 and is equivalent to “delay” in the keyword data example 820. Reference numeral 1122 shows that term numbers 19 and 20 corresponds to numeric number 5 and are equivalent to “7 (or more) days” in the numeric data example 920.

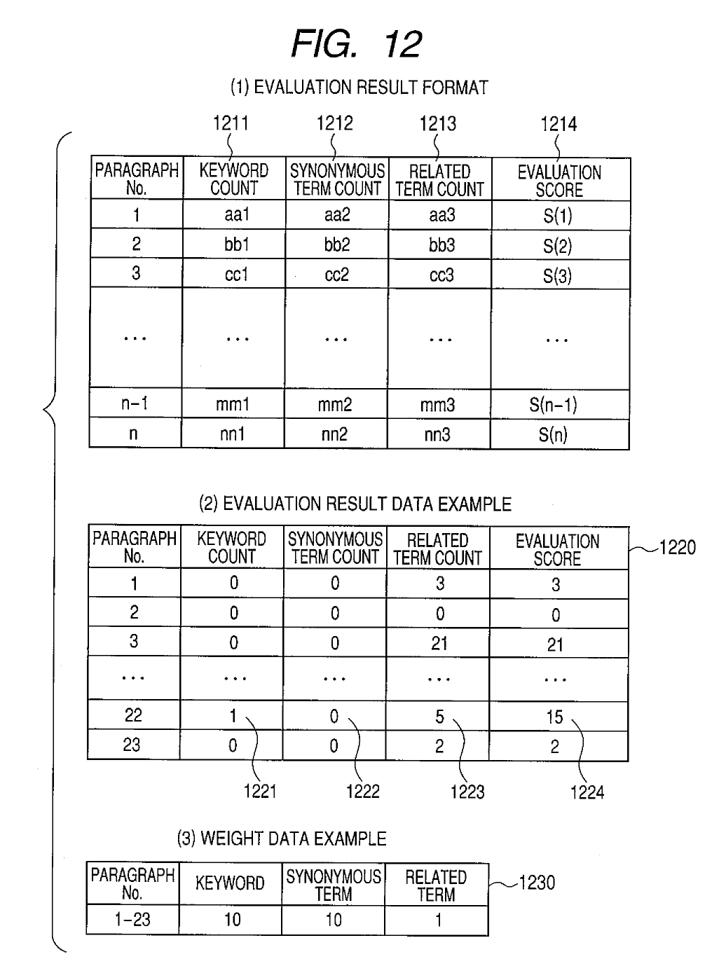

FIG. 12 shows an example of an evaluation result database 116. The evaluation result database 116 provides a search result (search count) of keywords, synonymous or similar terms, and related terms specified for the paragraphs by the search result evaluation unit 114 in FIG. 1. An evaluation result format 1210 is applied to all paragraphs and includes search result counts item 1211, 1212 and 1213 for the keyword, the synonymous or similar term, and the related term, and an evaluation score item 1214 evaluated using weight data assigned to each search target. In an evaluation result data example 1220, paragraph number “22” indicates the keyword count as “1”, the synonymous or similar term count as “0”, and the related term count as “5”. A weight data example 1230 provides a keyword weight as “10”, a synonymous or similar term weight as “10”, and a related term weight as “1”. These weights are used to calculate evaluation score S(22) as “15.”

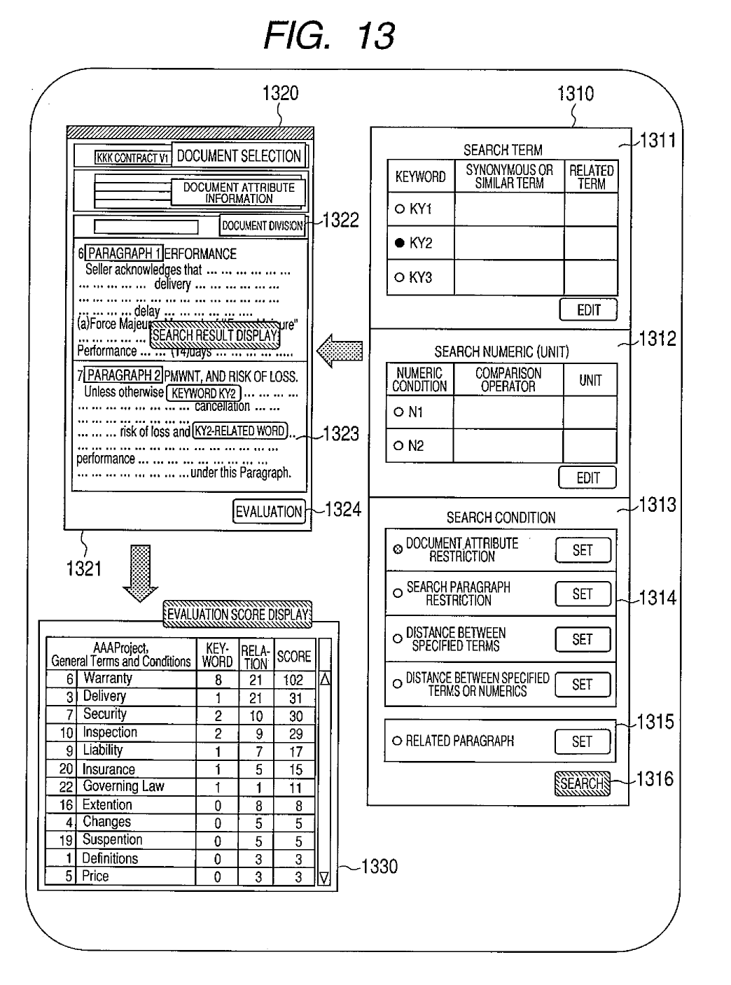

FIG. 13 shows an example display screen displayed after the search method is supplied to the document evaluation support system. The screen displays a search result indicative of searched locations in a document and an evaluation result in terms of evaluation scores for the paragraphs indicative of degrees of association with the search terms. A search method input section 1310 includes a search term input section 1311, a search numeric input section 1312, and a search condition input section 1313. The search word input section 1311 specifies a keyword that is stored in the keyword database and is selected from categorized keywords as a search keyword. The search numeric input section 1312 specifies a numeric, unit, and size that are stored in the numeric database. The search condition input section 1313 is used to enter a search condition. The search condition input section 1313 includes a term and numeric search condition input section 1314 and an associated paragraph search condition input section 1315. The term and numeric search condition input section 1314 can input the following four types (1)-(4): (1) document attribute information; (2) search target paragraph; (3) two specified terms; and (4) a specified term and a specified numeric. The associated paragraph search condition input section 1315 is used to enter a paragraph associated with the specified term. These input settings are used to specify arguments needed for the searches and to create the search condition database. A document display section 1320 first displays a document name and document attribute information followed by the document divided by the document division determination process and constituent paragraphs (1321). This example shows that the document is divided into “paragraph 1” and “paragraph 2.” To further divide the document, a user may specify a desired term in the document as a “paragraph” on the screen and performs the document division process (1322). The system can update the paragraph database to add the new paragraph by the document division process. The user sets a document to be searched and search conditions, and then performs the search (1316). The search result shows the document containing the specified search term or numeric in color. In this example, the specified keyword (KY2) is displayed with pink characters, the synonymous or similar term with orange characters, and the related term with blue-black characters (1323). The user further specifies calculation of an evaluation score for each paragraph (1324). The system calculates the evaluation score for each paragraph (1330). The system outputs the result in the order of paragraphs or in an ascending order. The user can confirm whether or not the result contains a paragraph closely associated with the search term or a paragraph requiring another search term.

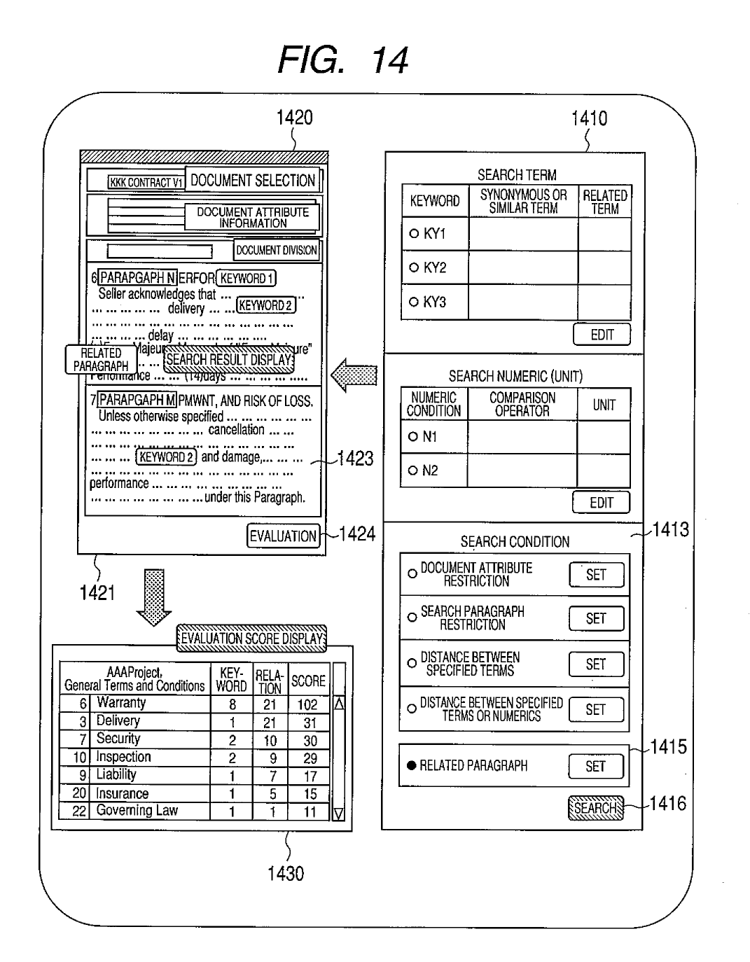

FIG. 14 shows an example display screen displayed after the search method is supplied to the document evaluation support system. The screen displays a search result indicative of searched locations in a document and an evaluation result in terms of evaluation scores for the paragraphs indicative of degrees of association with the search items. A search method input section 1410 is used to input a search condition and includes a search condition input section 1413. The search condition input section 1413 includes an associated paragraph search condition input section 1415. The associated paragraph search condition input section 1415 is used to search for a paragraph associated with a term specified in the search condition input section 1413. Setting the associated paragraph search condition input section 1415 configures an argument (specified paragraph) needed for the search and creates the search condition database. A document display section 1420 displays the document divided by the document division process and associated items (1421). When the document to be searched and the search conditions are set, and the search is performed (1316), as a result, the specified search term is displayed in the document and is colored. In this example, the system searches all the documents for the keyword that is contained in the first specified paragraph and is stored in the keyword database. The keyword is displayed with pink characters, the synonymous or similar term with orange characters, and the related term with blue-black characters (1423). The user further specifies calculation of an evaluation score for each paragraph (1424). The system calculates the evaluation score for each paragraph (1430). The system outputs the result in the order of paragraphs or in an ascending order. The user can confirm a paragraph closely associated with the searched paragraph.

The invention can be applied to, for example, a document management system that acquires useful information from various documents or helps search a document for terms so as to confirm the description of the document.

What is claimed is:

1. A document evaluation support system for searching a document for a specified term or terms and providing a search result, comprising
a device for defining a search condition for the specified term or terms by using a predetermined evaluation method.

2. The document evaluation support system according to claim 1,
wherein the system is configured so that the document is provided with attribute information and a full text of the document is divided into one or more sections automatically or manually.

3. The document evaluation support system according to claim 1,
wherein the specified term or terms signify at least one of one or more terms, numerics, numerics with units, sized numerics, and sized numerics with units; and
the system is configured to classify each specified term into one or more groups including weighted information according to importance.

4. The document evaluation support system according to claim 1,
wherein the evaluation method is to provide a constraint condition used when searching the document for the specified term or terms and determine whether or not to search for the specified term or terms in accordance with document attribute information.

5. The document evaluation support system according to claim 1,
wherein the evaluation method is to provide a constraint condition used for searching the document for the specified term or terms and specify a search range in the document to search for the specified term or terms.

6. The document evaluation support system according to claim 1,
wherein the evaluation method is to provide a constraint condition used for searching the document for the specified terms and search for the specified terms restricting a distance between specified terms.

7. The document evaluation support system according to claim 1,
wherein the system is configured to provide the search result with a display color corresponding to weighted information about each specified term.

8. The document evaluation support system according to claim 1,
wherein the system is configured to provide the search result by dividing a full text of the document into one or more sections, calculating an evaluation score by using the number of specified terms and weighted information about each section, and displaying the search result in descending or ascending order of values of the evaluation score.

9. The document evaluation support system according to claim 1,
wherein the system is configured to provide the search result displaying an alarm phrase and a necessary fixed phrase in accordance with the evaluation method, specified term, and an evaluation score value.

10. The document evaluation support system according to claim 1,
wherein the system is configured to divide a full text of the document into one or more sections and search for the specified term or terms included in a selected section across the full text of the document when one of the sections is selected as the section to be searched.

11. A document evaluation support method for searching a document for a specified term or terms and providing a search result, the method comprising a process of defining a search condition for the specified term or terms by using a predetermined evaluation method.

12. The document evaluation support method according to claim 11,
wherein the document is provided with attribute information and a full text of the document is divided into one or more sections automatically or manually.

13. The document evaluation support method according to claim 11,
wherein the specified term or terms signify at least one of one or more terms, numerics, numerics with units, sized numerics, and sized numerics with units, and each specified term is classified into one or more groups including weighted information according to importance.

14. The document evaluation support method according to claim 11,
wherein the evaluation method provides a constraint condition used for searching the document for the specified term or terms and determines whether or not to search for the specified term or terms in accordance with document attribute information.

15. The document evaluation support method according to claim 11,
wherein the evaluation method provides a constraint condition used when searching the document for the specified term or terms and specifies a search range in the document to search for the specified term and terms.

16. The document evaluation support method according to claim 11,
wherein the evaluation method provides a constraint condition used for searching the document for the specified terms and searches the specified terms restricting a distance between specified terms.

17. The document evaluation support method according to claim 11,
wherein the method provides the search result using a display color corresponding to weighted information about each specified term.

18. The document evaluation support method according to claim 11,
wherein, when providing the search result, the method comprises further processes of dividing a full text of the document into one or more sections, calculating an evaluation score by using the number of specified terms and weighted information about each section, and displaying the search result in descending or ascending order of values of the evaluation score.

19. The document evaluation support method according to claim 11,
wherein, when providing the search result, the search result is displayed including an alarm phrase and a necessary fixed phrase in accordance with the evaluation method, specified term, and an evaluation score value.

20. The document evaluation support method according to claim 11,
wherein, when searching the document for the specified term or terms, the method comprising further processes of dividing a full text of the input document into one or more sections, and searching for the specified term or terms included in a selected item across the full text of the document when one of divided texts is selected as the section to be searched.

21. A document evaluation support system comprising:
a document database for storing a document to be searched;
an division determination rule database for storing a determination rule for dividing the document into one or more sections;
a division determination unit for automatically dividing a full text of the document into one or more sections in accordance with the division determination rule;
a division specification input unit for allowing a user to divide a full text of the document into one or more sections;
a headed section database for storing the paragraphs into which the document is divided automatically or according to user specification with the addition to headings;
a keyword database for storing a term to be searched for;
a numeric database for storing numeric data to be searched for;
a search condition database for storing a constraint condition for search;
a search process input unit for inputting an evaluation method;
a specified term search unit for searching the document for the specified term;
a search result display unit for displaying a search result;
an evaluation rule database for storing an evaluation rule to evaluate the search result;
a search result evaluation unit for evaluating the search result according to the evaluation rule; and
an evaluation result display unit for displaying an evaluation result.
